(19) United States
(12) Patent Application Publication
(10) Pub. No.: US 2015/0319141 A1
(43) Pub. Date: Nov. 5, 2015

(54) UNSEND FEATURE IN MESSAGING APPLICATIONS

(71) Applicant: Frankly Co., San Francisco, CA (US)

(72) Inventors: Jinhwa Jang, Seongnam-si (KR); Hun Namkoong, Seongnam-si (KR); Heeyong Kim, Seongnam-si (KR)

(21) Appl. No.: 14/700,063

(22) Filed: Apr. 29, 2015

Related U.S. Application Data
(60) Provisional application No. 61/986,739, filed on Apr. 30, 2014.

(51) Int. Cl. H04L 29/06; H04L 12/58; G06F 17/30; G06F 3/0484

(52) U.S. Cl. CPC H04L 63/0421; G06F 3/0484; H04L 51/046; G06F 17/30117

(57) ABSTRACT

A message generated at a sender device is received at a messaging server via a network. The message is transmitted to a recipient device, where it is displayed in a modified format at least partly obscuring content of the message. A command is received from the sender device to unsend the transmitted message after transmitting the message to the recipient device. The messaging server determines whether the message has been displayed in an unobscured form at the recipient device, and, responsive to the message not having been displayed in the unobscured form at the recipient device, transmits a command to the recipient device to delete the message at the recipient device.

### CROSS-REFERENCE TO RELATED APPLICATION

This application claims the benefit of U.S. Provisional Patent Application No. 61/986,739, filed Apr. 30, 2014, which is incorporated herein by reference in its entirety.

### BACKGROUND

1. Field of Art

This disclosure generally relates to the field of online messaging services, and more particularly to unsending messages in online messaging services.

2. Description of the Related Art

In recent years, a number of messaging service applications have been published for general usage by a variety of different developers. By installing these messaging applications on their computing or mobile devices, people can communicate quickly with their friends or contacts via the messaging applications. Users may send messages, files, videos, audio recordings, and the like to their friends through these messaging applications. Some of these messaging applications also have additional features such as status postings, timelines, mini-games, in-application stores, and so forth.

When engaging in a private conversation with a contact, the user may wish to go “off the record.” This is especially true when the user is communicating sensitive information in the messages such as personal information (e.g., credit card number, bank account number, etc.) and/or confidential information. However, current messaging applications typically leave digital footprints (e.g., records, transcripts, screenshots, etc.) when users exchange information, regardless of whether the information is sensitive or not.

### SUMMARY

A messaging service transmits messages between user computing devices in a network environment. A messaging application executing on a sender device enables a user to create and send messages, and a messaging application executing on a recipient device displays the messages to a recipient. A messaging server may facilitate communications between the sender device and recipient device, including identifying the recipient device to receive the message, encoding messages and providing keys to decode the messages at the recipient device, and transmitting commands between the sender device and recipient device when a message is read or deleted.

In one embodiment, a messaging application executing on a recipient device receives a message from a sender device. The message is displayed in a modified format, which obscures content of the message. Responsive to receiving an input from a user to display a decoded message, the messaging application decodes the message and displays the decoded message. Responsive to receiving an unsend command from the sender device, the messaging application deletes the message.

In one embodiment, a messaging application executing on a sender device transmits a message to a recipient device. The recipient device is configured to display the message in a modified format obscuring content of the message. The messaging application receives an input from a user of the sender device to unsend the transmitted message, and determines whether the message has been read at the recipient device. Responsive to the message being unread at the recipient device, the messaging application transmits a command to the recipient device to delete the message.

In one embodiment, the messaging server receives, via a network, a message generated at a sender device. The message is transmitted to a recipient device, causing the recipient device to display the message in a modified format at least partly obscuring content of the message. After the message is transmitted to the recipient device, a command is received from the sender device to unsend the transmitted message. The messaging server determines whether the message has been displayed in an unobscured form at the recipient device. If the message has not been displayed in the unobscured form at the recipient device, the messaging server transmits a command to the recipient device to delete the message at the recipient device.

### BRIEF DESCRIPTION OF THE DRAWINGS

The disclosed embodiments have other advantages and features which will be more readily apparent from the detailed description, and the accompanying figures (or drawings). A brief introduction of the figures is below.

Figure (FIG. 1 illustrates an environment for using messaging applications to exchange information, according to one embodiment.

FIG. 2 is a block diagram of a messaging service server, according to one embodiment.

FIG. 3A is a block diagram illustrating a detailed view of a client device, according to one embodiment.

FIG. 3B is a block diagram illustrating modules within an applications module in a client device, according to one embodiment.

FIG. 4A is an example graphical user interface displaying a message sent by a sender, according to one embodiment.

FIG. 4B is an example graphical user interface for unsending a message, according to one embodiment.

FIG. 4C is an example graphical user interface displaying a message in a modified format, according to one embodiment.

FIG. 4D is an example graphical user interface displaying a message in a readable format, according to one embodiment.

FIG. 5A is an interaction diagram illustrating a process for sending messages in a private mode, according to one embodiment.

FIG. 5B is an interaction diagram illustrating a process for unsending messages, according to one embodiment

### DETAILED DESCRIPTION

The Figures and the following description relate to preferred embodiments by way of illustration only. It should be noted that from the following discussion, alternative embodiments of the structures and methods disclosed herein will be readily recognized as viable alternatives that may be employed without departing from the principles of the disclosure. It is noted that wherever practicable, similar or like reference numbers may be used in the figures and may indicate similar or like functionality.

Embodiments relate to unsending messages in a messaging service. After a message is transmitted from a sender device to a recipient device communicating with the sender device over a network, a user input is received at the sender device to unsend the message. If the message has not been read at the recipient device, the sender device transmits a command to the recipient device to delete the message. The sender device may also delete the message after transmitting the command to the recipient device.

As used herein, a messaging service or messaging application (hereinafter referred to as “messenger applications”) refers to any program or object installed on a computing device that provides users with the capability to communicate with other users via a network. The messenger application may be a software program, client, widget, applet, or any other type of application executable by the computing device. In particular, a messenger application executing on a first computing device (referred to herein as a “sender device”) can be used by a user to send a message to a messenger application executing on a second computing device (referred to herein as a “recipient device”).

Furthermore, as used herein, an “unsend command” refers to instructions generated at a sender device and transmitted to a recipient device (optionally via a messaging server) that cause the recipient device to delete a message specified by the instructions.

### System Architecture

FIG. 1 is an example environment 100 for using messaging applications to exchange information, according to one embodiment. As shown in FIG. 1, the environment 100 includes a plurality of client devices 105a through 105d (collectively referred to herein as “client devices 105”), a network 110, and a messaging server 115. The client devices 105 communicate with other client devices 105 and one or more messaging servers 115 via a network 110. While only one messaging server 115 and four client devices 105 are shown in FIG. 1 for purposes of clarity, the environment 110 can have multiple messaging servers 115 and varying numbers of client devices 105.

The client devices 105 are computing devices capable of processing data as well as transmitting and receiving data via the network 110. For example, a client device 105 may be a mobile device, a smartphone, a tablet computing device, a desktop computer, a laptop computer, a smart television, a set-top box, a gaming console, or any other device having computing and data communication capabilities. The client devices 105 are coupled to the network 110, which may include any combination of local area, cellular, wireless, and/or terrestrial communication systems.

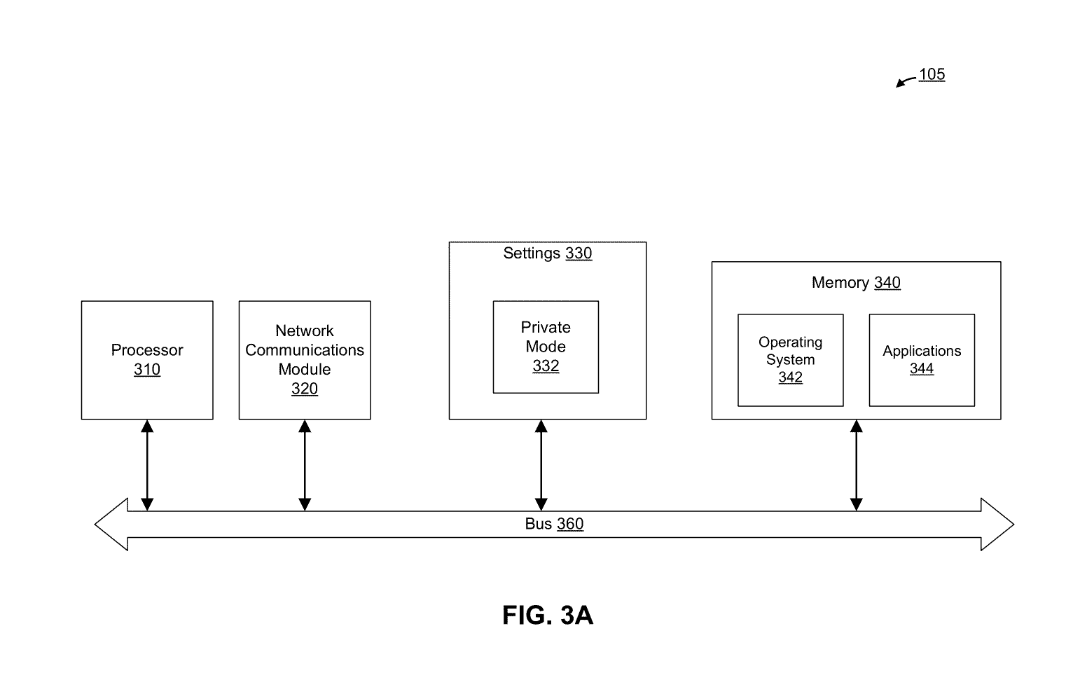

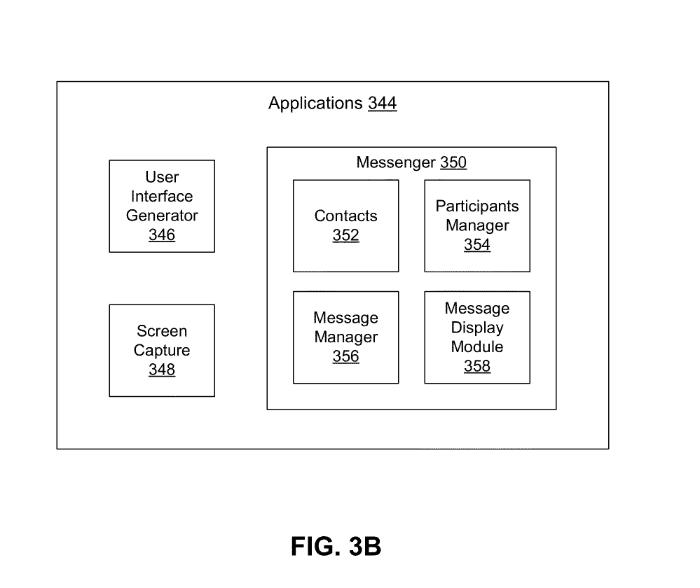

The client devices 105 enable users to send messages to users of other client devices 105. In one embodiment, the client devices 105 support both one-on-one messaging and group messaging. For example, a user of the client device 105a may send individual messages to the user of the client device 105, or may send group messages to the users of the client devices 105b, 105c, and 105d. In one embodiment, the client devices 105 support private communications between users. To provide private communications, the client devices 105 may, for example, encode messages transmitted between devices, display messages in a modified, unreadable format until the messages have been decoded, delete read messages, disable screen capture of messages, or anonymize participants in a conversation. In one embodiment, the client devices 105 enable users to unsend messages sent to other client device users by deleting the messages before the recipients read the messages. The components of client device 105 are described below in detail with reference to FIGS. 3A and 3B.

The network 110 enables communications between the various entities of the environment 100. In one embodiment, the network 110 uses standard communications technologies and/or protocols.

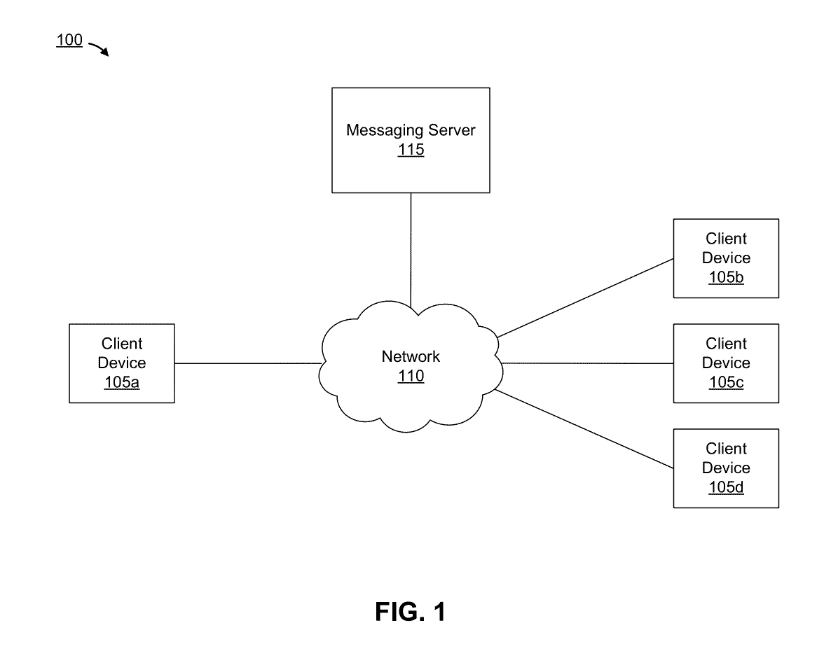

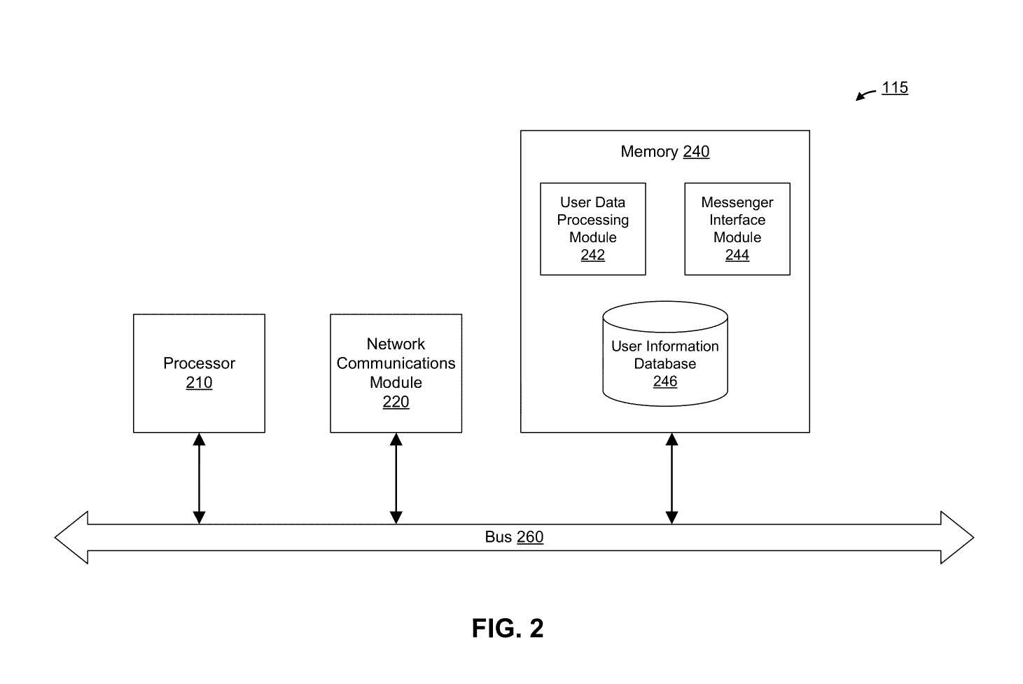

The messaging server 115 is a computer system performing various operations associated with storing, receiving, and transmitting messages to the client devices 105 via the network 110. The server 115 may include a singular computing system such as a single computer, or a network of computing systems such as a data center or a distributed computing system. The messaging server 115 may also perform operations to enhance privacy associated with conversations in the private mode including, among others, anonymizing the users and switching conversation mode from a group discussion to 1:1 conversation. The components and the function of the messaging server 115 is described below in detail with reference to FIG. 2.

### Messaging Server

FIG. 2 is an example high-level block diagram illustrating a detailed view of the messaging server 115, according to one embodiment. The modules, components, and operations depicted in FIG. 2 may be run on a computing system, such as the messaging server 115. In one embodiment, the messaging server 115 includes a processor 210, a network communications module 220, and a memory 240 communicating through a bus 260.

The processor 210 enables the messaging server 115 to read and execute instructions, such as those present on a computer-readable storage medium as well as those received from external computing systems.

The network communications module 220 enables the messaging server 115 to communicate with other devices connected to the network 110. In an embodiment, the network communications module 220 facilitates communications between the network 110 and the messaging server 115, transforming data from the messaging server 115 into transmission protocols that can be sent through the network 110.

The memory 240 is a machine-readable medium that stores instructions and data (e.g., software, programs, codes, files, and the like) that are executable by the processor 210. Some embodiments of the memory 240 include non-volatile memory such as hard drives, compact disk read-only memory (CD-ROM), digital video disks (DVD), solid-state memory devices and flash drives as well as volatile memory such as RAM (random access memory) and caches. Some instructions and data may also reside, at least partially, in the processor 210 (e.g., within a processor's cache memory) during execution. In one embodiment, data associated with conversations conducted between the users are stored only in the volatile memory and are not stored in the non-volatile memory. Hence, the users or messages associated with the conversations are subsequently overwritten by other data and are not retrievable after a certain time.

Instructions and data stored in the memory 240 may be transmitted or received over the network 110 via the network communications module 220. In one embodiment, the memory 240 stores instructions for a user data processing module 242, instructions for a messenger interface module 244, and a user information database 246. Other embodiments of the memory 240 may have different modules than the embodiment shown in FIG. 2.

The user data processing module 242 receives user information sent from a client device 105 and compiles the data for transmitting to other client devices 105. In one embodiment, the user data processing module 242 stores the messages transmitted between the users of conversations in a non-private mode setting. The stored messages may be provided to the users or other entities in the form of transcripts. The user data processing module 242 disables storing of messages between the users of conversations in a private mode setting. Since no message is stored for private conversations, transcripts for such conversations are unavailable from the messaging server 115. One way of preventing the storage of private conversations is to process data associated with conversations in the private mode setting only on volatile memory of the server 115 without storing the data in a non-volatile memory.

The messenger interface module 244 manages communications between the client devices 105. The message interface module 244 establishes a communication link with a messenger application installed on the client devices 105 to receive information from and transmit data to the client devices 105. The message interface module 244 monitors and facilitates message, audio, video, and other data exchanges between the client devices 105. For example, when the client device 105a sends a message to the client device 105b, the messenger interface module 244 receives the message and transmits it to the client device 105b based on tags or metadata attached to the message. The messenger interface module 144 may also establish and stabilize video communications (e.g., video chats, video conferences, video messages, and so forth) between two or more client devices 105. In one embodiment, messages transmitted between client devices 105 are encoded, and the messenger interface module 244 provides keys for decoding the messages in response to requests from the client devices 105.

The user information database 246 is a storage database for the user information received from the client devices 105. In an embodiment, information received by the user data processing module 242 and the messenger interface module 244 may be stored in the user information database 246. This information includes, but is not limited to, user profiles (e.g., names, user email addresses, age, and gender), chat histories, contact lists, privacy settings, messenger configuration settings, user system specifications, user system settings, user-transferred media files (e.g., videos, audio files, images, data files, documents, and so forth), and network connection properties of the client devices 105. The messaging server 115 may retrieve information from the user information database 246 in order to respond to requests from the client devices 105 for user information. Moreover, information stored in the user information database 246 may be used to determine privacy settings for users. For example, the user information database 246 may have privacy settings that indicate which specific contacts may receive information from, transmit information to, or established a secure communication channel (e.g., a private mode) with a particular user.

### Structure and Functionality of Client Devices

FIG. 3A is an example high-level block diagram illustrating a detailed view of a client device 105, in accordance with an embodiment. The modules, components, and operations depicted in FIG. 3A may be run on a computing system, such as a client device 105. The client device 105 may include, among other components, a processor 310, a network communications module 320, and a memory 340 that are linked together through a bus 360. Other embodiments of the client device 105 include additional or fewer modules, and a client device 105 may have different configurations of the presented modules as well as other modules that are not shown in FIG. 3A.

The processor 310 enables the client device 105 to read and execute instructions, such as those present on a computer-readable storage medium as well as those received from external computing systems. For example, a processor 310 may include a central processing unit (CPU), a graphics processing unit (GPU), a digital signal processor (DSP), one or more application-specific integrated circuits (ASICs), one or more radio-frequency integrated circuits (RFICs), or any combination of these. The processor 310 may also receive data from memory 340 or another device, process the data according to received instructions, and store the processed data in memory 340.

The network communications module 320 enables the client device 105 to communicate with other devices connected to the network 110. In an embodiment, the network communications module 320 facilitates communications between the network 110 and the client device 105, transforming data from the client device 105 into transmission protocols that can be sent through the network 110. For example, the network communications module 320 may convert the data to or from wireless signals that may be transmitted via cellular, WiFi, Bluetooth or other wireless technologies. The network communications module 320 may also convert the data to or from Internet protocols such as TCP/IP, UDP, HTTP, SMTP, FTP, SSL, TLS, VPN, IPsec and so forth.

The memory 340 is a machine-readable medium that stores instructions and data (e.g., software, programs, codes, files and the like) that are used in the client device 105. Some embodiments of the memory 340 include hard drives, CD-ROM, DVD, solid-state memory devices, flash drives, caches and so forth. Some instructions and data may also reside, at least partially, in the processor 310 (e.g., within a processor's cache memory) during execution. Instructions and data in the memory 340 may be transmitted or received over the network 110 via the network communications module 320. In an embodiment, the memory 340 may include an operating system 342 and applications 344. Other embodiments of the memory 340 may have more, less, and/or different modules than the embodiment shown in FIG. 3A.

The operating system 342 is a specialized application that manages computer hardware resources of the client device 105 and provides common services to the applications 344. Examples of the operating system 342 include WINDOWS, MAC OS, IOS, LINUX, UBUNTU, UNIX, and ANDROID.

The applications 344 may include any program, software, code, or data that is stored and executes on the client device 105. Some applications 344 may come pre-installed on the client device 105 and are available for use when the user first starts to use client device 105. Other applications 344 may be downloaded into the client device 105 and installed at later times.

Turning to FIG. 3B, an embodiment of the applications 344 includes a user interface generator 346, a screen capture application 348, and a messenger 350. The application 344 may include other applications not depicted in FIG. 3B, such as phone applications, SMS applications, media players, Internet browsers, calculator applications, gaming applications, social networking applications, camera/video capture applications, mapping applications, weather applications, and download store applications.

The user interface generator 346 generates an interface for the user to interact with the client device 105 and other applications 344 on the client device 105. In an embodiment, the user interface generator 346 generates icons, pictures, keyboard input screens, windows, visuals, characters, and other displays for the user to see. The user interface generator 346 may also receive user inputs via user gestures such as screen taps, screen swipes, button presses and so forth. The user interface generator 346 receives these user inputs and converts them into data that other applications 344 may recognize. For example, the user interface generator 346 may display a message entry screen and an on-screen keyboard for the user to input text for messages. As the user selects characters on the displayed on-screen keyboard, the user interface generator 346 receives and converts the screen taps into characters for storing into the client device's memory 340.

The screen capture application 348 enables capturing of a screen for storing or transmittal to other users. The captured screen may be associated with various applications executed on the client device 105. A user may take a screen shot using the screen capture application 348, and store the screen shot in a memory and/or a hard disk for later retrieval. The captured screen may be in various image formats such as JPEG or GIF file. In one embodiment, the screen capture application 348 is disabled by the messenger application 350 when conversations are being conducted in a private mode.

The messenger application 350 enables communication between users of the client devices 105. For example, the messenger application 350 facilitates message sending, audio conversations, video chatting, file sharing, story posting, information sharing, and so forth between users. In one embodiment, the messenger application 350 supports private communications between users of the client devices 105. To maintain privacy of messages exchanged between users, the messenger application 350 may encode messages, delete read messages from one or both of the sender's client device 105 and the recipient's client device 105 after a specified period of time, and disable the screen capture application 348 of the client devices 105. The messenger application 350 may also anonymize participants in a conversation by, for example, hiding names, profile pictures, locations, or other identifying features of the participants.

The messenger application 350 includes various modules enabling users to send messages to and receive messages from other client device users. As shown in FIG. 3B, one embodiment of the messenger application 350 includes a contacts module 352, a participants manager 354, a message manager 356, and a message display module 358.

The contacts module 352 finds, maintains, and stores users' contact information. In an embodiment, the contacts module 352 may have search capabilities for the user to search for other users that are using the messenger application 350 on their client devices 105.

The participants manager 354 manages information related to participants of the conversation. For some conversations (e.g., conversations in a non-private mode setting), information of the participants such as geographic information (e.g., the city the participant lives in), status (e.g., driving, in office, etc.), pictures, names, occupations, hobby, and other information may be accessible. In one embodiment, the participants manager 354 anonymizes participants of conversations in the private mode setting so that the participants of the conversations are not readily identifiable based on the information presented on the client device. For example, some of the information of the users (e.g., picture and names) may be hidden and not visible on the window associated with the conversation in the private mode setting.

Furthermore, the participants manager 354 may switch the chat mode from a group mode with more than two participants to 1:1 mode where only two participants are allowed in the conversation. In one approach, the participants manager 354 launches a separate private chat room for the two users, while the same users are allowed to continue to participate in the group discussion. In other cases, the two users may be pulled out of the group discussion and forced to engage only in the 1:1 conversation in the private mode.

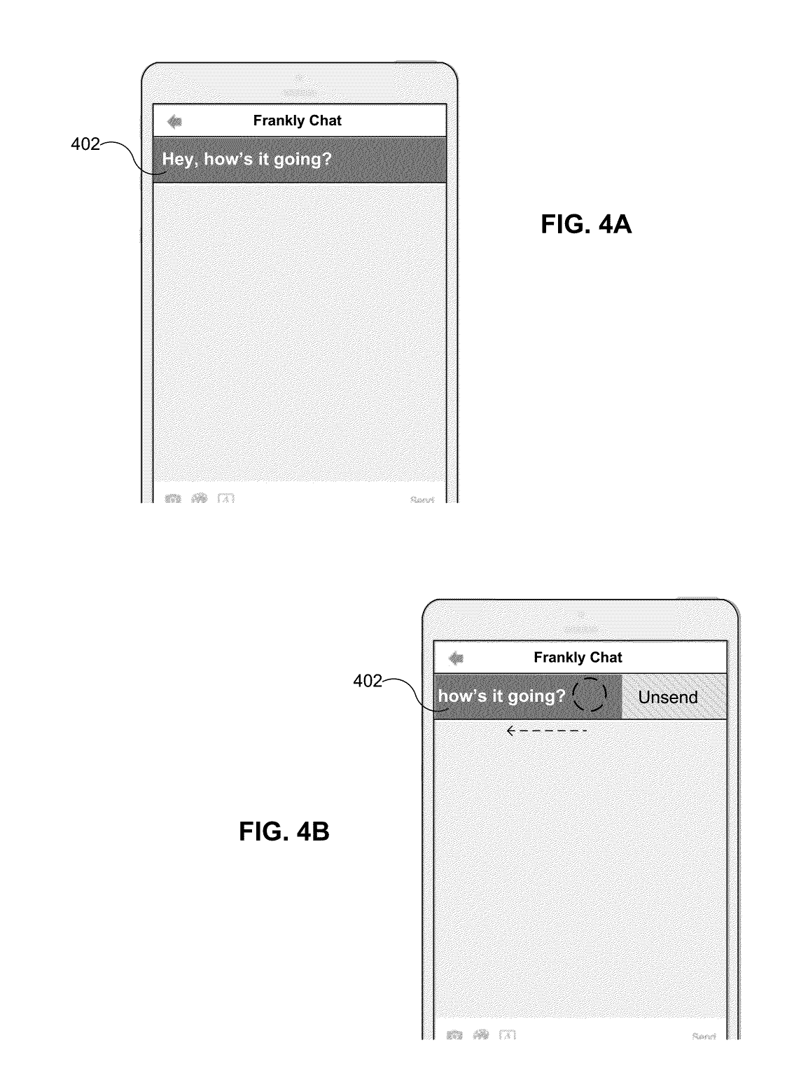

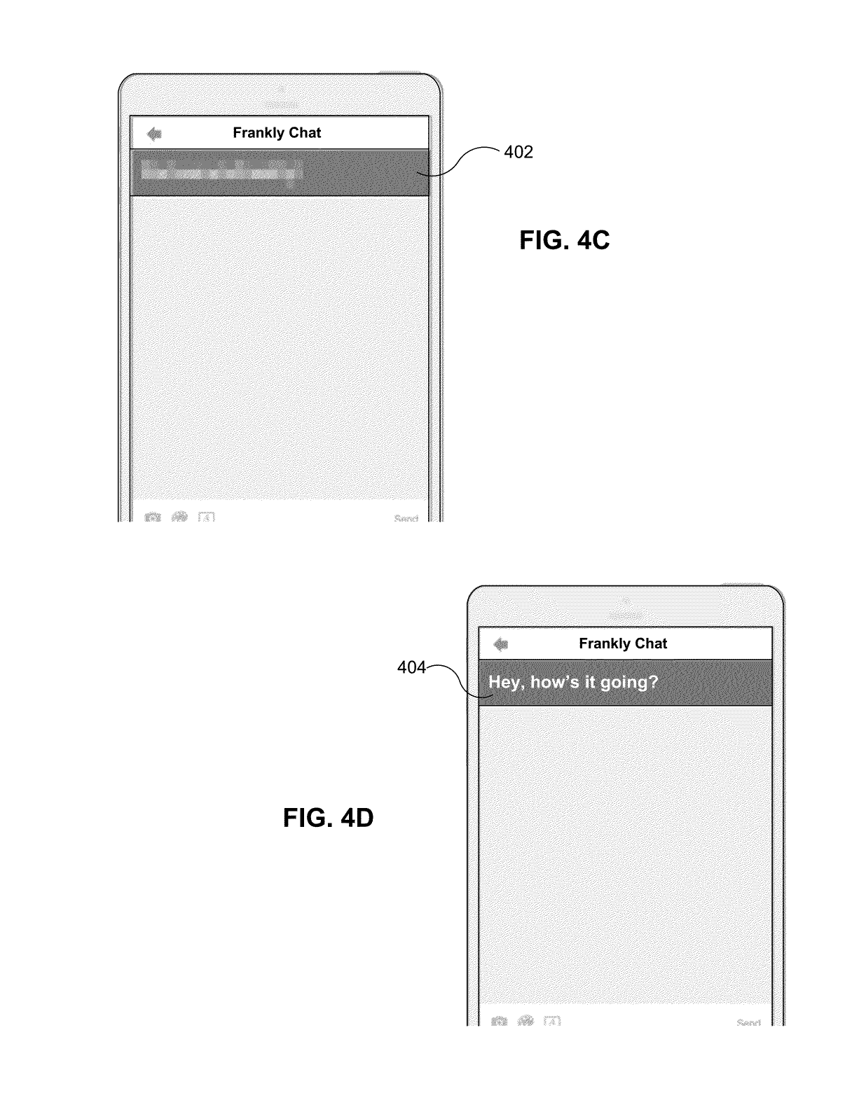

The message manager 356 enables users of the client devices 105 to create messages for communicating with other users. The message manager 356 provides an interface for the user to select one or more recipients of a message and create or add content (such as text, a picture, or a video) to the message. After a message has been sent to the selected recipients, one embodiment of the message manager 356 also enables the user to unsend the message. For example, the message manager 356 receives a user interaction with the message interface as an input to unsend the message. In various embodiments, the user interaction may include a gesture to swipe the message off the display screen of the client device 105, an interaction with a dedicated user interface element (e.g., an “x” or an “unsend” button), or the like. FIG. 4A illustrates an example message 402 sent to a recipient and displayed on the sender's client device 105. As shown in the example of FIG. 4B, the sender unsends the message 402 by dragging the message 402 to the left side of the device's display screen as if to swipe the message 402 off the display. Other gestures may alternatively be used to unsend the message.

In one embodiment, the message manager 356 determines an encryption level (e.g., high, medium, low, etc.) and an encryption algorithm (e.g., 3DES, DES, RC2, etc.) to be used for messages in the conversation. For example, a high encryption level and a strong encryption algorithm may be chosen for conversations in the private mode setting compared to conversations in the non-private mode setting.

The message display module 358 displays messages to recipients. One embodiment of the message display module 358 initially displays messages in a modified format to render the message indecipherable to the recipient. For example, as shown in FIG. 4C, the message display module 358 displays the message as a pixelated image 404, obscuring the content of the message. A pixelated image or another image may alternatively be overlaid on the message to at least partly obscure the content of the message. If a message has not been unsent before a user input is received to display the message, the message display module 358 displays the message to the recipient in an unobscured (i.e., decipherable) format in response to receiving the user input. For example, the message display module 358 displays a message that is readable to the user in response to a user tapping on the modified message. FIG. 4D illustrates an example of a readable message 406 displayed in response to a user tapping on the pixelated message 404 shown in FIG. 4C. In one embodiment, the messages received at a recipient's client device 105 are encoded. To display a message in an unobscured format, the message display module 358 retrieves a key for decoding the message from the messaging server 115 and decodes the message using the key. After displaying an unobscured message for a specified interval of time (e.g., ten seconds), the message display module 358 may delete the message.

### Messenger Operations

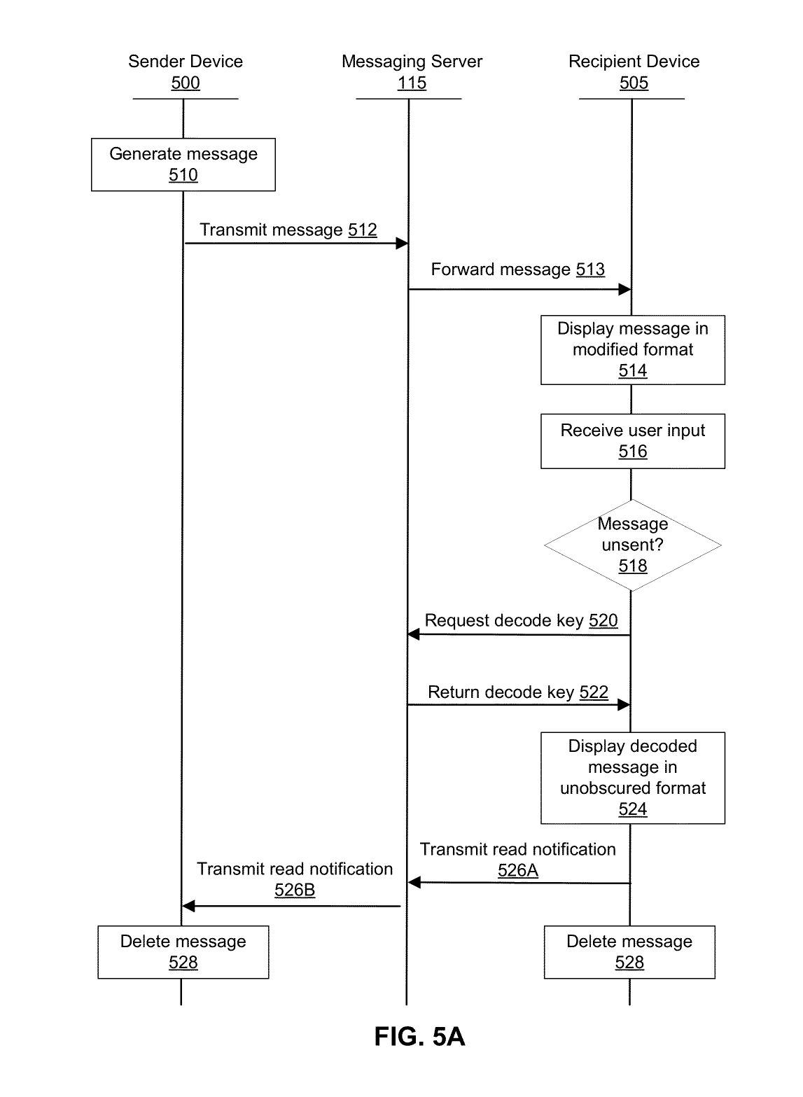

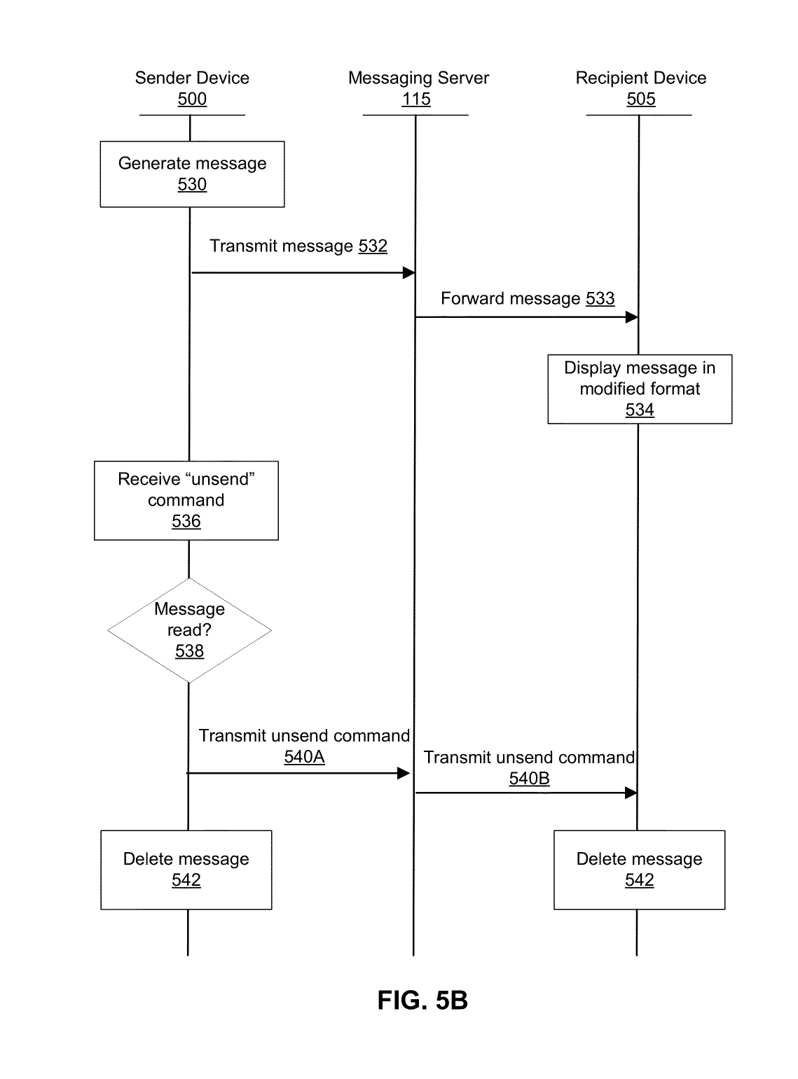

FIG. 5A is a flow diagram illustrating a process for sending messages in a private mode, according to one embodiment. As shown in FIG. 5A, the process includes interactions between the messaging server 115, a sender device 500, and a recipient device 505. In one embodiment, the sender device 500 and recipient device 505 are similar to the client devices 105 described above, and each executes a messenger application 350.

A user of the sender device 500 uses the messenger application 350 executing on the sender device 500 to generate 510 a message. The message may include text, pictures, videos, and/or other content. The sender device 500 transmits 512 the message to the messaging server 115, which identifies the recipient device of the intended recipient and forwards 513 the message to the recipient device 505. In one embodiment, the messaging server 115 forwards 513 the message to the recipient device 505 without storing the message.

The recipient device 505 receives the message from the messaging server 115 and displays 514 the message in a modified format. For example, the recipient device 505 displays the message as a pixelated image or overlays a pixelated image on the message, hiding the content of the message until the message is decoded. To read the message, the user of the recipient device 505 provides a user input, such as tapping on the modified image of the message displayed by the recipient device 505. The recipient device 505 receives 516 the user input, and in response determines 518 whether the message has been unsent. If the message has not been unsent, the recipient device 505 requests 520 a key for decoding the message from the messaging server 115. The messaging server 115 returns 522 the decode key, which the recipient device 505 uses to decode the message and display 524 the decoded message to the user in an unobscured format. In one embodiment, the recipient device 505 displays 524 the decoded message for a limited period of time, such as ten seconds. After decoding the message, the recipient device 505 in one embodiment transmits 526A a read notification to the messaging server 115, which forwards 526B the read notification to the sender device 500. Alternatively, the messaging server 115 generates the read notification and transmits 526B the read notification to the sender device 500 in response to the recipient device 505 requesting 520 the key for decoding the message.

After the message has been read at the recipient device 505, the sender device 500 and the recipient device 505 delete 528 the message. In one embodiment, the message is deleted 528 at the sender device 500 and the recipient device 505 a specified length of time (such as ten seconds) after the recipient device 505 displays 524 the decoded message in the unobscured format or transmits 526A the read notification to the sender device 500 via the messaging server 115.

One embodiment of the messenger application 350 enables users to unsend messages that have not been read by one or more of the recipients. FIG. 5B is a flow diagram illustrating a process for unsending messages, according to one embodiment. As shown in FIG. 5B, the process includes interactions between the messaging server 115, the sender device 500, and the recipient device 505.

A user of the sender device 500 uses the messenger application 350 executing on the sender device 500 to generate 530 a message. The sender device 500 transmits 532 the message to the messaging server 115, which forwards 533 the message to the recipient device 505. The recipient device 505 may display 534 the message in a modified format.

To unsend the message, the user of the sender device 500 inputs an unsend command to the sender device 500. The unsend command may include swiping an image of the message to a side of the display screen of the sender device 500, selecting an “unsend” user interface element (such as an “x,” an “unsend” button, etc.), or performing another action on the sender device 500. The sender device 500 receives 536 the unsend command, and determines 538 whether the message has been read at the recipient device 505. In one embodiment, the sender device 500 determines 538 whether the message has been read at the recipient device 505 by checking for receipt of a read notification on the message from the recipient device 505. If a read notification has not been received, the sender device 500 determines the message has not been read. If the message has not been read, the sender device 500 transmits 540A the unsend command to the messaging server 115, which in turn transmits 540B the unsend command to the recipient device 505. The sender device 500 and the recipient device 505 delete 542 the message. For example, the sender device 500 deletes 542 the message in response to transmitting 540A the unsend command, and the recipient device 505 deletes 542 the message in response to receiving the unsend command from the messaging server 115.

The operations shown in FIGS. 5A and 5B may be performed in different orders or by different entities than illustrated. For example, in response to receiving 516 the user input to read the message as shown in FIG. 5A, the recipient device 505 requests 520 the key for decoding the message from the messaging server 115. The messaging server 115 in turn determines 518 if the message has been unsent by the sender device 500, and returns the decode key to the recipient device 505 if the message has not been unsent. As another example, in response to receiving 536 the unsend command from a user as shown in FIG. 5B, the sender device 500 may transmit 540A the unsend command to the messaging server 115. The messaging server 115 in turn determines 538 if the message has been read at the recipient device 505 and transmits 540B the unsend command to the recipient device 505 if the message has not been read. In one embodiment, the messaging server 115 determines the message has been read at the recipient device 505 if a read notification has been received from the recipient device 505. In another embodiment, the messaging server 115 determines the message has been read at the recipient device 505 if the recipient device 505 has requested a key to decode the message.

### Additional Embodiments

The foregoing description of the embodiments has been presented for the purpose of illustration; it is not intended to be exhaustive or to limit the invention to the precise forms disclosed. Persons skilled in the relevant art can appreciate that many modifications and variations are possible in light of the above disclosure.

Some portions of this description describe the embodiments in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a non-transitory computer-readable medium containing computer program instructions, which can be executed by a computer processor for performing any or all of the steps, operations, or processes described.

Embodiments may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a tangible computer readable storage medium, which includes any type of tangible media suitable for storing electronic instructions, and coupled to a computer system bus. Furthermore, any computing systems referred to in the specification may include a single processor or may be architectures employing multiple processor designs for increased computing capability.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

What is claimed is:

1. A method for preserving privacy of messages in a messaging service, the method comprising:
receiving a message from a sender device via a network;
displaying the received message by a receiving device in a modified format at least partly obscuring content of the message;
responsive to receiving an input from a user to display the received message in an unobscured form, decoding the received message;
displaying the decoded message in the unobscured form; and
responsive to receiving an unsend command from the sender device, deleting the message.

2. The method of claim 1, further comprising:
responsive to displaying the decoded message for a specified interval of time, deleting the message.

3. The method of claim 1, wherein the message is received from the sender device via a messaging server communicating with the sender device and the receiving device over the network, and wherein decoding the message comprises:
responsive to receiving the input from the user, requesting a key from the messaging server; and
processing the message into the unobscured form using the key.

4. The method of claim 1, wherein the modified format comprises a pixelated image.

5. The method of claim 1, wherein the message includes at least one of text, an image, and a video.

6. A method for preserving privacy of messages in a messaging service, the method comprising:
transmitting a message from a sender device to a recipient device via a network causing the recipient device to display the message in a modified format at least partly obscuring content of the message;
receiving an input from a user to unsend the transmitted message after transmitting the message to the recipient device;
determining whether the message has been displayed in an unobscured format at the recipient device;
responsive to the message not having been displayed in the unobscured format at the recipient device, transmitting a command to the recipient device to delete the message at the recipient device.

7. The method of claim 6, further comprising:
responsive to transmitting the command to the recipient device to delete the message, deleting the message stored in the sender device.

8. The method of claim 6, further comprising:
receiving, from the recipient device via the network, a read notification indicating that the message has been decoded and displayed at the recipient device in the unobscured format; and
determining that the message has been read responsive to receiving the read notification.

9. The method of claim 6, further comprising:
displaying the transmitted message on a display screen of the sender device;
wherein the input to unsend the transmitted message comprises a swipe gesture to swipe the transmitted message off the display screen.

10. The method of claim 6, wherein the message is transmitted to a plurality of recipient devices, and wherein transmitting the command to the recipient device to delete the message comprises transmitting the command to each of the plurality of recipient devices at which the message has not been read.

11. The method of claim 6, wherein the modified format comprises a pixelated image.

12. The method of claim 6, wherein the message includes at least one of text, an image, and a video.

13. A non-transitory computer-readable storage medium comprising executable computer program code, the computer program code when executed by a processor causing the processor to:
receive a message from a sender device via a network;
display the received message by a receiving device in a modified format at least partly obscuring content of the message;
responsive to receiving an input from a user to display the received message in an unobscured form, decode the received message;
display the decoded message in the unobscured form; and
responsive to receiving an unsend command from the sender device, delete the message.

14. The non-transitory computer-readable storage medium of claim 13, further comprising computer program code that when executed by the processor causes the processor to:
responsive to displaying the decoded message for a specified interval of time, delete the message.

15. The non-transitory computer-readable storage medium of claim 13, wherein the message is received from the sender device via a messaging server communicating with the sender device and the receiving device over the network, and wherein decoding the message comprises:
responsive to receiving the input from the user, request a key from the messaging server; and
process the message into the unobscured form using the key.

16. The non-transitory computer readable storage medium of claim 13, wherein the modified format comprises a pixelated image.

17. A method for preserving privacy of messages in a messaging service, the method comprising:
receiving at a messaging server via a network, a message generated at a sender device;
transmitting the message to a recipient device, causing the recipient device to display the message in a modified format at least partly obscuring content of the message;
receiving a command from the sender device to unsend the transmitted message after transmitting the message to the recipient device;
determining whether the message has been displayed in an unobscured form at the recipient device; and
responsive to the message not having been displayed in the unobscured form at the recipient device, transmitting a command to the recipient device to delete the message at the recipient device.

18. The method of claim 17, further comprising:
receiving a request from the recipient device to display the received message in the unobscured form;
determining whether the command to unsend the transmitted message has been received from the sender device; and
responsive to determining the command to unsend the transmitted message has not been received, transmitting to the recipient device, a key to decode the message and display the message in the unobscured form.

19. The method of claim 17, further comprising:
responsive to determining the message has been displayed in the unobscured form at the recipient device, sending a command to the sender device to delete the message in the sender device.

20. The method of claim 17, wherein the message is not stored in the messaging server after transmitting the message to the recipient device.

21. A non-transitory computer-readable storage medium comprising executable computer program code, the computer program code when executed by a processor causing the processor to:
receive a message from a sender device via a network;
transmit the message to a recipient device, causing the recipient device to display the message in a modified format at least partly obscuring content of the message;
receive a command from the sender device to unsend the transmitted message after transmitting the message to the recipient device;
determine whether the message has been displayed in an unobscured form at the recipient device; and
responsive to the message not having been displayed in the unobscured form at the recipient device, transmit a command to the recipient device to delete the message at the recipient device.

22. The non-transitory computer-readable medium of claim 21, further comprising computer program code that when executed by the processor causes the processor to:
receive a request from the recipient device to display the received message in the unobscured form;
determine whether the command to unsend the transmitted message has been received from the sender device; and
responsive to determining the command to unsend the transmitted message has not been received, transmitt to the recipient device, a key to decode the message and display the message in the unobscured form.

23. The non-transitory computer-readable medium of claim 21, further comprising computer program code that when executed by the processor causes the processor to:
responsive to determining the message has been displayed in the unobscured form at the recipient device, send a command to the sender device to delete the message in the sender device.

24. The non-transitory computer-readable medium of claim 21, wherein the message is not stored in the messaging server after transmitting the message to the recipient device.
